(19) United States
(12) Patent Application Publication
(10) Pub. No.: US 2026/0347240 A1
(43) Pub. Date: Nov. 5, 2026

(54) IRRADIATION-RESISTANT GLASS HAVING GAMMA-RAY SHIELDING AND NEUTRON PROTECTION FUNCTIONS AND PREPARATION METHOD THEREFOR

(71) Applicant: CNBM PHOTONICS TECHNOLOGY CO., LTD., Zaozhuang (CN)

(72) Inventors: Shengyun YANG, Zaozhuang (CN); Zhenbo CAO, Zaozhuang (CN); Meilun ZHANG, Zaozhuang (CN); Ke WANG, Zaozhuang (CN); Yu HAN, Zaozhuang (CN); Qiao WANG, Zaozhuang (CN); Yang ZHANG, Zaozhuang (CN); Jinsheng JIA, Zaozhuang (CN); You ZHOU, Zaozhuang (CN); Haifeng LV, Zaozhuang (CN); Fu QIU, Zaozhuang (CN)

(21) Appl. No.: 19/488,139

(22) PCT Filed: Dec. 4, 2024
(86) PCT No.: PCT/CN2024/136607

§ 371 Date: Nov. 26, 2025

(30) Foreign Application Priority Data
Dec. 6, 2023 (CN) 202311660224.0

(51) Int. Cl. C03C 4/08; C03B 25/00; C03C 3/07; C03C 3/105; G21F 1/06

(52) U.S. Cl. CPC C03C 4/08; C03B 25/00; C03C 3/07; C03C 3/105; G21F 1/06

(57) ABSTRACT

Irradiation-resistant glass having γ-ray shielding and neutron protection functions and a preparation method therefor. The glass material is prepared from the following components in percentage by mass: 25-45% of SiO₂, 45-55% of PbO, 0.5-5% of Gd₂O₃, 0.5-1.5% of CeO₂, 0.5-5% of Al₂O₃, 0-10% of Na₂O, 2-10% of K₂O, and 0-3% of an alkaline earth metal oxide selected from at least one of CaO and MgO, CaO and MgO being not both 0. The glass material has excellent gamma ray shielding performance, a good neutron protection function, and irradiation resistance, can be used for preparing a nuclear radiation shielding window, and has wide popularization and application prospects in complex environments in which gamma rays and neutron radiation are both present, e.g., nuclear power stations, nuclear power facilities, radiation diagnosis and treatment, and space detection.

### CROSS-REFERENCE TO RELATED APPLICATIONS

The present application claims the benefit and priority of Chinese Application No. CN202311660224.0, entitled “IRRADIATION-RESISTANT GLASS HAVING GAMMA-RAY SHIELDING AND NEUTRON PROTECTION FUNCTIONS AND PREPARATION METHOD THEREFOR,” filed on Dec. 6, 2023. The entire contents of the above application are incorporated herein by reference for all purposes.

### TECHNICAL FIELD

The present application relates to the field of glass technology, and particularly relates to irradiation-resistant glass having gamma-ray shielding and neutron protection functions and preparation method therefor.

### BACKGROUND

Any discussion of the prior art throughout the specification should not be construed as an admission that such prior art is widely known or forms part of the common general knowledge in the art.

In the field of applications of nuclear energy and radioactive materials-especially in nuclear power plants, nuclear-propulsion facilities, radiation diagnosis and therapy, and space exploration-effective radiation protection is critically important. Nuclear reactions release high-energy radiation or particles such as alpha (α), beta (β), and gamma (γ) rays and neutrons, which pose serious threats to human health and the normal operation of instruments. As an important facility that allows researchers or operators to observe, from one side of an operating room, processes such as nuclear-waste solidification, spent-fuel purification, and nuclear-material processing, a nuclear-radiation shielding window places extremely high requirements on the shielding performance and irradiation resistance of the material used.

In radiation protection, α and β radiation have weak penetrating power and are readily absorbed, and therefore are not usually the primary focus. By contrast, the high energy and strong penetrating power of γ rays and neutrons make them the key consideration when selecting shielding materials. Existing gamma-ray shielding methods rely mainly on high-density materials such as lead or lead-based alloys, which, owing to their high atomic number, can effectively absorb γ rays. However, these materials are typically heavy, lack flexibility, and undergo performance degradation under long-term radiation exposure. For neutron shielding, materials containing large amounts of light elements (e.g., hydrogen) are generally required, because light elements can effectively slow and absorb neutrons. Common neutron-shielding materials include borated polyethylene and water. However, these materials often perform poorly in γ-ray shielding and lack the required mechanical strength and chemical stability, thereby limiting their applications.

At present, few shielding materials on the market can simultaneously and effectively shield both gamma rays and neutrons, and many suffer from drawbacks such as excessive weight, little or no optical transmittance, and performance degradation under prolonged irradiation.

### SUMMARY

The present invention provides irradiation-resistant glass having gamma-ray shielding and neutron protection functions and a method for preparing the same. The glass material provided exhibits excellent gamma-ray shielding performance, good neutron protection, and irradiation resistance, can be used to prepare nuclear radiation-shielding windows, and has broad prospects for application in complex environments where gamma and neutron radiation are present simultaneously, such as nuclear power plants, nuclear power facilities, radiation diagnosis and therapy, and space exploration.

Specifically, the present invention provides the following technical solutions.

In a first aspect of the present invention, a glass material is provided, which comprises or consists of the following components in percent by mass: 25%-45% SiO₂, 45%-55% PbO, 0.5%-5% Gd₂O₃, 0.5%-1.5% CeO₂, 0.5%-5% Al₂O₃, 0%-10% Na₂O, 2%-10% K₂O, and 0-3% of an alkaline earth metal oxide selected from at least one of CaO and MgO, where the CaO and the MgO are not both 0% by mass.

In some embodiments of the present invention, the glass material comprises the following components in percent by mass: 25%-45% SiO₂, 45%-55% PbO, 0.5%-5% Gd₂O₃, 0.5%-1.5% CeO₂, 0.5%-5% Al₂O₃, 0%-10% Na₂O, 2%-10% K₂O, and 0.1%-3% of the alkaline earth metal oxide selected from at least one of the CaO and the MgO.

In some embodiments of the present invention, the glass material consists of the following components in percent by mass: 25%-45% SiO₂, 45%-55% PbO, 0.5%-5% Gd₂O₃, 0.5%-1.5% CeO₂, 0.5%-5% Al₂O₃, 0%-10% Na₂O, 2%-10% K₂O, and 0.1%-3% of the alkaline earth metal oxide selected from at least one of the CaO and the MgO, the total content of all components being 100%.

According to the embodiments of the present invention, at a thickness of 20 mm, the glass material of the present invention has a ⁶⁰Co gamma-ray shielding rate ≥40.47%, a thermal neutron shielding rate ≥92.63%, a transmittance at 560 nm ≥86.42%, a transmittance at 560 nm after irradiation with gamma rays at a total dose of 10,000 Gy ≥82.61%, and a transmittance decrease at 560 nm after the irradiation ≤6.67%.

SiO₂, as a glass-forming oxide, is a main component for building the glass skeleton network structure. In the above embodiments of the present invention, the content of SiO₂ in percent by mass is 25%-45%. Further, the content of SiO₂ in percent by mass may be 25%-40%, 40%-45%, 25%-30%, 25%-29%, 25%-28%, 25%-27%, 28%-40%, 30%-40%, 30%-31%, 31%-40%, 25%-31%, 28%-31%, and the like. In the glass composition of the present invention, the above SiO₂ content helps provide structural stability and chemical durability and helps maintain transparency and irradiation resistance. An excessively high SiO₂ content will raise the melting point of the glass, leading to difficulty and increased cost in glass melting and processing. An excessively low SiO₂ content will render the glass skeleton network structure insufficiently robust, thereby reducing the structural stability and chemical durability of the glass, making the glass more susceptible to chemical corrosion and environmental factors, and affecting the optical properties of the glass.

Lead is a heavy metal element with a relatively high atomic number and a relatively high mass attenuation coefficient; therefore, PbO has been widely used in the field of radiation shielding, and as the PbO content increases, shielding materials often exhibit better radiation shielding capability. However, an excessively high PbO content will reduce the thermal stability of the glass, affect the transmittance of the glass in the visible region and cause yellowing of the glass material, and also pose environmental and health risks. In the above embodiments of the present invention, the content of PbO in percent by mass is 45%-55%. In the glass composition of the present invention, this PbO content helps balance the radiation shielding capability, optical transmittance, and irradiation resistance of the glass. Further, in the above embodiments, the content of PbO in percent by mass may be 46%-55%, 48%-55%, 48.7%-55%, 50%-55%, 51%-55%, 52%-55%, 53%-55%, 54%-55%, 45%-53%, 48%-53%, 48.7%-53%, 50%-53%, 45%-50%, 46%-50%, 48%-50%, 48.7%-50%, 45%-48.7%, 46%-48.7%, 48%-48.7%, 45%-48%, 46%-48%, and the like.

The Gd element has a large thermal neutron absorption cross section (the thermal neutron microscopic absorption cross section of ¹⁵⁵Gd is 61,000 barns and that of ¹⁵⁷Gd is 255,000 barns) and is widely used in the fields of nuclear physics and nuclear medicine for neutron shielding and neutron capture. However, the inventors have found that addition of Gd₂O₃ often affects the transparency and chemical stability of the glass; in particular, when excessive Gd is added, the glass is prone to phase separation, which affects spectral transmittance. In the above embodiments of the present invention, the content of Gd₂O₃ in percent by mass is 0.5%-5%. Further, it may be 1%-5%, 2%-5%, 3%-5%, 4%-5%, 1%-3%, 2%-3%, 3%-4%, 0.5%-3%, and the like. In the glass composition of the present invention, the above Gd₂O₃ content helps balance the radiation shielding capability, chemical stability, and optical transmittance of the glass material.

CeO₂ is typically used as a stabilizer. In the glass structure, a valence equilibrium of Ce³⁺⇄Ce⁴⁺+e⁻ exists, wherein Ce³⁺ has a tendency to capture holes and be oxidized, forming Ce³⁺⁽⁺⁾, and Ce⁴⁺ has a tendency to capture free electrons and be reduced, forming Ce⁴⁺⁽⁻⁾, so that free electrons generated by irradiation cannot enter defects in the glass structure, thereby preventing formation of color centers and avoiding glass coloration. However, excessive CeO₂ may also cause a color change of the glass, thereby affecting its transparency and aesthetics. In the above embodiments of the present invention, a too high or too low CeO₂ content will affect the optical properties of the glass material and reduce optical transmittance. Moreover, an excessively high content will also affect the viscosity and fluidity of the glass melt, affect the melting process, and affect the structural completeness and mechanical properties of the glass; whereas a too low content will reduce the chemical stability of the glass material and reduce the ability of the glass material to block ultraviolet light and radiation. In the above embodiments of the present invention, the content of CeO₂ in percent by mass is 0.5%-1.5%. Further, it may be 0.5%-1.2%, 0.5%-1.0%, 0.5%-0.6%, 1%-1.5%, 1%-1.2%, 0.6%-1.5%, 0.6%-1.2%, 0.6%-1.0%, and the like. In the glass composition of the present invention, the above CeO₂ content helps balance the optical properties, chemical stability, and structural stability of the glass material.

Na₂O and K₂O are network-modifying oxides of the glass. Alkali metal ions can readily move and diffuse in the glassy body, reducing the viscosity of the glass during high-temperature melting and making the glass easier to melt; they are therefore good fluxes. In the present invention, the inventors have found that excessively high contents of Na₂O and K₂O will reduce the chemical stability, thermal stability, and mechanical strength of the glass, increase the thermal expansion coefficient of the glass, and readily lead to greater stress in the glass under temperature fluctuations, thereby affecting its optical properties such as transmittance and optical homogeneity, and may dilute the concentration of high-atomic-number elements in the glass, reducing radiation shielding efficiency and leading to decreased stability. To better balance the above properties and obtain a glass material with superior overall performance, in the above embodiments of the present invention, the content of K₂O in percent by mass is 2%-10%. Further, it may be 2%-6.9%, 2%-6.8%, 2%-3.9%, 2%-2.5%, 2.5%-10%, 2.5%-6.9%, 2.5%-6.8%, 2.5%-3.9%, 3.9%-10%, 3.9%-6.9%, 3.9%-6.8%, 6.8%-10%, 6.8%-6.9%, 6.9%-10%, and the like. The content of Na₂O in percent by mass is 0%-10%. Further, it may be 0%-2%, 0%-4%, 0%-4.5%, 0%-7.3%, 2%-7.3%, 2%-4.5%, 2%-4%, 4%-10%, 4%-7.3%, 4%-4.5%, 4.5%-10%, 4.5%-7.3%, and the like.

Al₂O₃ serves as a network intermediate in forming the glass structure. Its content affects the thermal expansion coefficient and the chemical and thermal stability of the glass. Al₂O₃ can improve the mechanical processing performance of the glass, but an excessive amount will reduce “viscosity property of glass” (i.e., the melt working range). In the course of research, the inventors found that even a small amount of Al₂O₃ can lead to tiny crystallization in the glass because Al₂O₃ has poor solubility in the glass melt. If the glass melt contains Al₂O₃—even in very small amounts—the melting temperature must be increased to about 1,550 °C to obtain a transparent glass melt. However, such a high melting temperature is undesirable and uneconomical.

CaO and MgO are alkaline earth metal oxides and are network-modifying oxides in the glass structure. In the course of research, the inventors found that addition of CaO and/or MgO will affect the optical transmittance and chemical stability of the glass, and excessive addition will also dilute the concentration of lead or gadolinium, thereby affecting the radiation shielding effect.

In the above embodiments of the present invention, the inventors found that, on the basis of a glass composition containing 25%-45% SiO₂, 45%-55% PbO, 0.5%-5% Gd₂O₃, 0.5%-1.5% CeO₂, 0%-10% Na₂O, and 2%-10% K₂O, by simultaneously adding specific amounts of Al₂O₃ and an alkaline earth metal oxide selected from at least one of CaO and MgO, the resulting glass material not only has good optical transmittance but also has a good radiation shielding capability.

In particular, the maximum high-temperature melting temperature for preparing the glass material of the present invention is only 1,350 °C. The specific amount of Al₂O₃ in the present invention is 0.5%-5% by mass; further, it may be 0.5%-4%, 0.5%-3%, 0.5%-2%, 0.5%-1%, 1%-5%, 1%-3%, 1%-2%, 2%-5%, 2%-3%, 3%-5%, and the like. The specific amount of the alkaline earth metal oxide selected from at least one of CaO and MgO in the present invention is such that the content of the alkaline earth metal oxide selected from at least one of CaO and MgO is 0.1%-3% by mass, preferably 0.5%-2.5%, further optionally 0.5%-2% or 1.5%-2.5%, and particularly 1.5%-2%. In particular, in some embodiments of the present invention, the content of CaO in percent by mass is 0%-2%, preferably 0.5%-2%, and more preferably 1%-2%. The content of MgO in percent by mass is 0%-1%, preferably 0%-0.5%, more preferably 0.5%-1%, and furthermore preferably 0.5% or 0%.

In particular, in some embodiments of the present invention, the glass material consists of the following components in percent by mass: 25%-45% of SiO₂, 45%-55% of PbO, 1%-5% of Gd₂O₃, 0.5%-1.2% of CeO₂, 0.5%-3% of Al₂O₃, 2%-7.3% or 0% of Na₂O, 2%-10% of K₂O, and 0.1%-3% of an oxide selected from at least one of CaO and MgO, the total content of all components being 100%.

Particularly, in some embodiments of the present invention, the glass material consists of the following components in percent by mass: 25%-45% SiO₂, 45%-55% PbO, 1%-5% Gd₂O₃, 0.5%-1.2% CeO₂, 0.5%-3% Al₂O₃, 2%-7.3% or 0% Na₂O, 2%-10% K₂O, 0.5%-2% CaO, and 0-1% MgO, the total content of all components being 100%.

Particularly, in some embodiments of the present invention, the glass material consists of the following components in percent by mass: 25%-45% SiO₂, 45%-55% PbO, 1%-5% Gd₂O₃, 0.5%-1.2% CeO₂, 0.5%-3% Al₂O₃, 2%-7.3% or 0% Na₂O, 2%-10% K₂O, 1.5%-2% CaO, and 0-1% MgO, the total content of all components being 100%.

Particularly, in some embodiments of the present invention, the glass material consists of the following components in percent by mass: 25%-45% SiO₂, 45%-55% PbO, 1%-5% Gd₂O₃, 0.5%-1.2% CeO₂, 0.5%-3% Al₂O₃, 2%-7.3% or 0% Na₂O, 2%-10% K₂O, and 0.5%-2% CaO, the total content of all components being 100%.

Particularly, in some embodiments of the present invention, the glass material consists of the following components in percent by mass: 25%-45% SiO₂, 45%-55% PbO, 1%-5% Gd₂O₃, 0.5%-1.2% CeO₂, 0.5%-3% Al₂O₃, 2%-7.3% or 0% Na₂O, 2%-10% K₂O, 1%-1.5% CaO, and 0.5-1% MgO, the total content of all components being 100%.

The specific technical features described in the foregoing embodiments may be combined in any suitable manner, provided there is no mutual conflict. To avoid unnecessary repetition, the various possible combinations are not set out separately herein.

Unless otherwise specified, the numerical ranges described herein include all values within the range and also include sub-ranges defined by any two values within the range. For example, the range of 1.5%-2% includes every value between 1.5% and 2%, and includes sub-ranges defined by any two values within that range (e.g., 1.51%-2%, 1.99%-2%, 1.51%-1.99%). Different numerical values of the same parameter appearing in the embodiments of the present invention may be combined arbitrarily to form a range.

In a second aspect of the present invention, there is provided a method for preparing the glass material described in the first aspect, the method comprising: mixing raw materials; high-temperature melting; auxiliary stirring and clarification; cooling and forming; and precision annealing to obtain the glass material.

In embodiments of the present invention, a high-temperature melting temperature is 1,235-1,350 °C, a forming temperature is 1,108-1,222 °C, and an annealing temperature is 405-450 °C.

In a third aspect of the present invention, there is provided a radiation-shielding material, which comprises the glass material described in the first aspect above or is made from the glass material described in the first aspect above.

In embodiments of the present invention, the radiation shielding material is used for shielding gamma rays and/or neutron radiation.

In a fourth aspect of the present invention, there is provided an optical element, which comprises the glass material described in the first aspect above or is made from the glass material described in the first aspect above.

In one embodiment of the present invention, the optical element is a radiation-shielding optical window element; the radiation is in particular gamma-ray radiation and/or neutron radiation.

In a fifth aspect of the present invention, there is provided the use of the glass material described in the first aspect above, the radiation-shielding material described in the third aspect above, or the optical element described in the fourth aspect above in the field of radiation shielding or optics.

In some embodiments of the present invention, the use includes but is not limited to use in the fields of nuclear power plant facilities, nuclear power facilities, radiation diagnosis and therapy, and space exploration.

By one or more of the foregoing technical means, the following beneficial effects can be achieved:

The present invention provides an irradiation-resistant glass having gamma-ray shielding and neutron-protection functions. The glass material exhibits excellent gamma-ray shielding performance, good neutron-protection and irradiation resistance, and good optical transmittance. At a thickness of 20 mm, the glass has a shielding rate against ⁶⁰Co gamma rays greater than 40.47%, a shielding rate against thermal neutrons greater than 92.63%, a transmittance at 560 nm greater than 86.42%, a transmittance at 560 nm after irradiation with gamma rays at a total dose of 10,000 Gy still greater than 82.61%, and a decrease in transmittance at 560 nm after such irradiation ≤6.67%. The glass material can be used to prepare nuclear radiation-shielding windows and has broad prospects for application in complex environments where gamma-ray and neutron radiation are present simultaneously, such as nuclear power plants, nuclear power facilities, radiation diagnosis and therapy, and space exploration.

### BRIEF DESCRIPTION OF THE DRAWINGS

The accompanying drawings, which form part of the present application, are provided to facilitate a further understanding of the present application. The schematic embodiments shown in the drawings and the descriptions thereof are given by way of illustration to explain the present application and are not to be construed as unduly limiting the present application. The embodiments of the present application are described in detail below with reference to the accompanying drawings, in which:

FIG. 1 shows a neutron energy spectrum obtained by moderating neutrons from a ²⁵²Cf source with polyethylene.

FIG. 2 shows a comparison of the transmittance at 560 nm of the glass material of Example 6 of the present invention before and after irradiation with a total dose of 10,000 Gy of gamma rays.

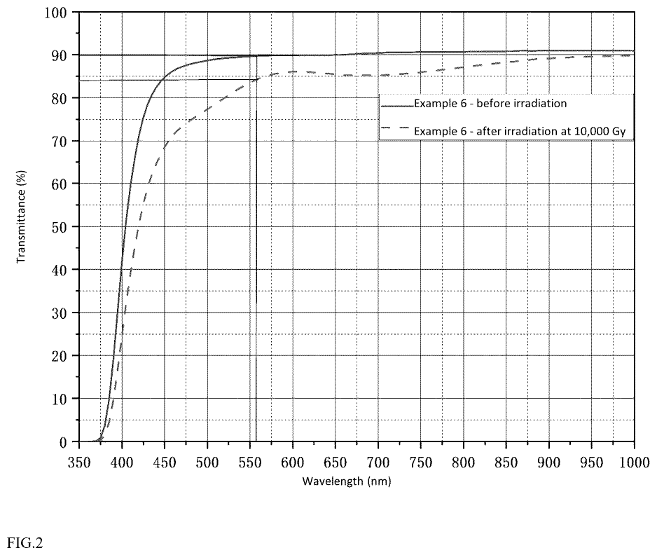

### DETAILED DESCRIPTION

The following specific embodiments are provided to further illustrate the present application. It should be understood that these embodiments are intended to illustrate the present application and are not intended to limit the scope thereof. Experimental methods in the following embodiments for which specific conditions are not indicated are generally carried out under conventional conditions or under conditions recommended by the manufacturer.

Unless otherwise defined, all technical and scientific terms used herein have the same meaning as commonly understood by those skilled in the art. The reagents or raw materials used in the present application can be obtained through conventional channels; unless otherwise specified, the reagents or raw materials used herein are employed in accordance with customary practices in the art or according to product instructions. In addition, any methods and materials similar or equivalent to those described can be applied to the methods of the present application. The preferred methods and materials described herein are provided by way of example only.

The performance parameters in the following examples were measured as follows:

A ⁶⁰Co gamma-ray shielding test was performed by the China Academy of Engineering Physics. Samples have dimensions of 150×150×50 mm. A NaI detector was used to measure the radiation background in the experimental space, and to collect the counts (n) at the two γ-ray full-energy peaks of 1.173 MeV and 1.332 MeV after the rays passed through the shielding material, as well as the counts (n₀) without a sample. Software was used to analyze and process the data, subtract the background, and take the net counts of the two ⁶⁰Co γ-ray full-energy peaks as the full-energy-peak counts. The γ-ray shielding rate I of the material was calculated using the formula

$$I = \frac{{n}_{0} - n}{{n}_{0}} \times 100 \% .$$

Transmittance test was carried out using an ultraviolet-visible-infrared (UV-Vis-NIR) spectrophotometer.

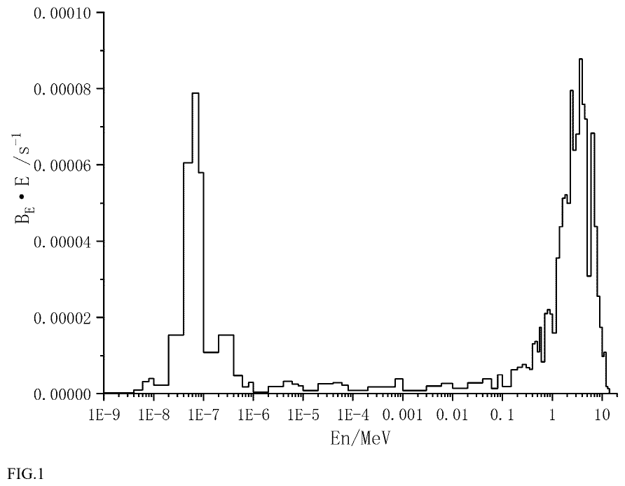

Thermal neutron shielding rate test: A ²⁵²Cf source was used to generate neutrons, and polyethylene was used as a moderator to slow fast neutrons to thermal neutrons. A neutron energy spectrum obtained by moderating the ²⁵²Cf source neutrons with the polyethylene is shown in FIG. 1. A ³He proportional counter was used to detect the response count rates of thermal and fast neutrons; this count rate included the total responses of thermal and fast neutrons not shielded by the material. To obtain the response count rate of the fast neutrons alone, the detector was wrapped with a cadmium sheet. Since cadmium strongly absorbs thermal neutrons, in this way the thermal neutron response was blocked and only the fast neutron response count rate was measured. In the test, the response count rate of “thermal neutrons+fast neutrons” without a sample is recorded as

$${N}_{0}^{′} ,$$

and the response count rate of “fast neutrons only” is recorded as

$${N}_{0 b}^{′} .$$

With the test sample inserted, the response count rate of “thermal neutrons+fast neutrons” is recorded as

$${N}_{s}^{′} ,$$

and the response count rate of “fast neutrons only” is recorded as

$${N}_{sb}^{′} .$$

The thermal neutron shielding rate (kₜₕ) of the material can be calculated using the following formula. The formula below reflects the change in the thermal neutron response count rate before and after inserting the test sample, thereby enabling evaluation of the shielding effect of the material on thermal neutrons:

$${k}_{th} = ( 1 - \frac{{N}_{s}^{′} - {N}_{sb}^{′}}{{N}_{0}^{′} - {N}_{0 b}^{′}} ) \times 1 \; 00 \% .$$

### Example 1

In this example, an irradiation-resistant glass material with gamma-ray shielding and neutron-protection functions consisted of the following components by mass percent: 40% SiO₂, 46% PbO, 5% Gd₂O₃, 0.5% CeO₂, 0.5% Al₂O₃, 4.5% Na₂O, 2% K₂O, 1% CaO, and 0.5% MgO.

The irradiation-resistant glass material with gamma-ray shielding and neutron-protection functions of this example was prepared using quartz sand, aluminum oxide, calcium carbonate, magnesium carbonate, red lead, cerium oxide, sodium carbonate, potassium carbonate, and gadolinium oxide as raw materials. After proportionally mixing the respective glass raw materials, the batch was melted at 1,301 °C, subjected to auxiliary stirring and clarification, mechanically formed at 1158 °C, and annealed at 438 °C to obtain the glass.

A 20 mm-thick sample of the glass material prepared by the method of this example exhibited a ⁶⁰Co gamma-ray shielding rate of 40.78%, a thermal neutron shielding rate of 96.00%, and, after irradiation with a total gamma-ray dose of 10,000 Gy, a transmittance at 560 nm of 83.55% (decrease of 6.46%).

### Example 2

In this example, the irradiation-resistant glass material with gamma-ray shielding and neutron-protection functions consisted of, by mass percentage: 30% SiO₂, 53% PbO, 4% Gd₂O₃, 0.6% CeO₂, 1% Al₂O₃, 4% Na₂O, 6.9% K₂O, and 0.5% CaO.

The irradiation-resistant glass material with gamma-ray shielding and neutron-protection functions of this example was prepared using quartz sand, aluminum oxide, calcium carbonate, lead silicate, cerium oxide, sodium nitrate, potassium carbonate, and gadolinium oxide as raw materials. After proportionally mixing the respective glass raw materials, the batch was melted at 1,257 °C, subjected to auxiliary stirring and clarification, mechanically formed at 1130 °C, and annealed at 411 °C to obtain the glass.

A 20 mm-thick sample of the glass material prepared by the method of this example exhibited a ⁶⁰Co gamma-ray shielding rate of 43.23%, a thermal neutron shielding rate of 95.36%, and, after irradiation with a total gamma-ray dose of 10,000 Gy, a transmittance at 560 nm of 83.00% (a decrease of 4.02%).

### Example 3

In this example, the irradiation-resistant glass material with gamma-ray shielding and neutron-protection functions consisted of, by mass percentage: 45% SiO₂, 45% PbO, 2% Gd₂O₃, 0.5% CeO₂, 1% Al₂O₃, 2% Na₂O, 2.5% K₂O, 1% CaO, and 1% MgO.

The irradiation-resistant glass material with gamma-ray shielding and neutron-protection functions of this example was prepared using quartz sand, aluminum hydroxide, calcium carbonate, magnesium carbonate, yellow lead, cerium oxide, sodium carbonate, potassium carbonate, and gadolinium oxide as raw materials. After proportionally mixing the respective glass raw materials, the batch was melted at 1,350 °C, subjected to auxiliary stirring and clarification, mechanically formed at 1,222 °C, and annealed at 450 °C to obtain the glass.

A 20 mm-thick sample of the glass material prepared by the method of this example exhibited a ⁶⁰Co gamma-ray shielding rate of 40.47%, a thermal neutron shielding rate of 93.65%, and, after irradiation with a total gamma-ray dose of 10,000 Gy, a transmittance at 560 nm of 82.95% (a decrease of 6.67%).

### Example 4

In this example, the irradiation-resistant glass material with gamma-ray shielding and neutron-protection functions consisted of, by mass percentage: 31% SiO₂, 48% PbO, 0.5% Gd₂O₃, 1.5% CeO₂, 5% Al₂O₃, 10% Na₂O, 3.9% K₂O, and 0.1% MgO.

The irradiation-resistant glass material with gamma-ray shielding and neutron-protection functions of this example was prepared using quartz sand, aluminum hydroxide, magnesium carbonate, lead silicate, cerium oxide, sodium nitrate, potassium carbonate, and gadolinium oxide as raw materials. After proportionally mixing the respective glass raw materials, the batch was melted at 1,266 °C, subjected to auxiliary stirring and clarification, mechanically formed at 1,138 °C, and annealed at 415 °C to obtain the glass.

A 20 mm-thick sample of the glass material prepared by the method of this example exhibited a ⁶⁰Co gamma-ray shielding rate of 42.10%, a thermal neutron shielding rate of 92.63%, and, after irradiation with a total gamma-ray dose of 10,000 Gy, a transmittance at 560 nm of 82.61% (a decrease of 3.81%).

### Example 5

In this example, the irradiation-resistant glass material with gamma-ray shielding and neutron-protection functions consisted of, by mass percentage: 28% SiO₂, 48.7% PbO, 1% Gd₂O₃, 1% CeO₂, 2% Al₂O₃, 7.3% Na₂O, 10% K₂O, 1.5% CaO, and 0.5% MgO.

The irradiation-resistant glass material with gamma-ray shielding and neutron-protection functions of this example was prepared using quartz sand, aluminum hydroxide, calcium carbonate, magnesium carbonate, red lead, cerium oxide, sodium carbonate, potassium carbonate, and gadolinium oxide as raw materials. After proportionally mixing the respective glass raw materials, the batch was melted at 1,235 °C, subjected to auxiliary stirring and clarification, mechanically formed at 1,108 °C, and annealed at 405 °C to obtain the glass.

A 20 mm-thick sample of the glass material prepared by the method of this example exhibited a ⁶⁰Co gamma-ray shielding rate of 42.49%, a thermal neutron shielding rate of 93.13%, and, after irradiation with a total gamma-ray dose of 10,000 Gy, a transmittance at 560 nm of 84.26% (a decrease of 4.42%).

### Example 6

In this example, the irradiation-resistant glass material with gamma-ray shielding and neutron-protection functions consists of, by mass percentage: 25% SiO₂, 55% PbO, 3% Gd₂O₃, 1.2% CeO₂, 3% Al₂O₃, 4% Na₂O, 6.8% K₂O, and 2% CaO.

The irradiation-resistant glass material with gamma-ray shielding and neutron-protection functions of this example uses quartz sand, aluminum hydroxide, calcium carbonate, red lead, cerium oxide, sodium carbonate, potassium carbonate, and gadolinium oxide as raw materials. After proportionally mixing the respective glass raw materials, the batch is melted at 1,241 °C, subjected to auxiliary stirring and clarification, mechanically formed at 1,117 °C, and annealed at 408 °C to obtain the glass.

A 20 mm-thick sample of the glass material prepared by the method of this example exhibits a ⁶⁰Co gamma-ray shielding rate of 43.36%, a thermal neutron shielding rate of 94.97%, and, after irradiation with a total gamma-ray dose of 10,000 Gy, a transmittance at 560 nm of 84.40% (a decrease of 5.33%).

### Example 7

In this example, the irradiation-resistant glass material with gamma-ray shielding and neutron-protection functions consisted of, by mass percentage: 35% SiO₂, 50% PbO, 2% Gd₂O₃, 1.5% CeO₂, 3% Al₂O₃, 6% K₂O, 2% CaO, and 0.5% MgO.

The irradiation-resistant glass material with gamma-ray shielding and neutron-protection functions of this example was prepared using quartz sand, aluminum oxide, calcium carbonate, magnesium carbonate, red lead, cerium oxide, potassium carbonate, and gadolinium oxide as raw materials. After proportionally mixing the respective glass raw materials, the batch was melted at 1,245 °C, subjected to auxiliary stirring and clarification, mechanically formed at 1,110 °C, and annealed at 420 °C to obtain the glass.

A 20 mm-thick sample of the glass material prepared by the method of this example exhibited a ⁶⁰Co gamma-ray shielding rate of 43.08%, a thermal neutron shielding rate of 93.97%, and, after irradiation with a total gamma-ray dose of 10,000 Gy, a transmittance at 560 nm of 82.89% (a decrease of 4.22%).

### Comparative Example 1

The glass material of this comparative example consisted of, by mass percentage: 48% SiO₂, 37.5% PbO, 1.5% CeO₂, 10% Na₂O, and 3% K₂O.

The glass material of this comparative example was prepared using quartz sand, red lead, cerium oxide, sodium carbonate, and potassium carbonate as raw materials, according to the method of Example 1.

A 20 mm-thick sample of the glass material prepared by the method of this comparative example exhibited a ⁶⁰Co gamma-ray shielding rate of 20.48%, a thermal neutron shielding rate of 80.46%, and, after irradiation with a total gamma-ray dose of 10,000 Gy, a transmittance at 560 nm of 70.19% (a decrease of 10.96%).

### Comparative Example 2

The glass material of this comparative example consisted of, by mass percentage: 48.6% SiO₂, 24.2% PbO, 7.5% Gd₂O₃, 18.1% K₂O, 1.4% CeO₂, and 0.2% F. The glass material of this comparative example was prepared using quartz sand, red lead, gadolinium oxide, cerium oxide, potassium carbonate, and potassium fluosilicate as raw materials, according to the method of Example 1.

A 20 mm-thick sample of the glass material prepared by the method of this comparative example exhibited a ⁶⁰Co gamma-ray shielding rate of 19.02%, a thermal neutron shielding rate of 96.26%, and, after irradiation with a total gamma-ray dose of 10,000 Gy, a transmittance at 560 nm of 58.35% (a decrease of 6.76%).

### Comparative Example 3

The glass material of this comparative example consisted of, by mass percentage: 26.49% SiO₂, 66.23% PbO, 5.68% Gd₂O₃, and 1.60% K₂O.

The glass material of this comparative example was prepared using quartz sand, red lead, potassium nitrate, and gadolinium oxide as raw materials, according to the method of Example 1.

A 20 mm-thick sample of the glass material prepared by the method of this comparative example exhibited a ⁶⁰Co gamma-ray shielding rate of 44.63%, a thermal neutron shielding rate of 95.90%, and, after irradiation with a total gamma-ray dose of 10,000 Gy, a transmittance at 560 nm of 48.28% (a decrease of 35.72%).

### Comparative Example 4

The glass material of this comparative example consisted of, by mass percentage: 28% SiO₂, 55% PbO, 3% Gd₂O₃, 1.2% CeO₂, 4% Na₂O, 6.8% K₂O, and 2% CaO.

The glass material of this comparative example was prepared using quartz sand, red lead, cerium oxide, sodium carbonate, potassium nitrate, gadolinium oxide, and calcium carbonate as raw materials, according to the method of Example 1.

A 20 mm-thick sample of the glass material prepared by the method of this comparative example exhibited a ⁶⁰Co gamma-ray shielding rate of 39.99%, a thermal neutron shielding rate of 92.42%, and, after irradiation with a total gamma-ray dose of 10,000 Gy, a transmittance at 560 nm of 52.61% (a decrease of 16.60%).

### Comparative Example 5

The glass material of this comparative example consisted of, by mass percentage: 27% SiO₂, 55% PbO, 3% Gd₂O₃, 1.2% CeO₂, 3.0% Al₂O₃, 4% Na₂O, and 6.8% K₂O.

The glass material of this comparative example was prepared using quartz sand, red lead, gadolinium oxide, cerium oxide, sodium carbonate, potassium nitrate, and gadolinium oxide as raw materials, according to the method of Example 1.

A 20 mm-thick sample of the glass material prepared by the method of this comparative example exhibited a ⁶⁰Co gamma-ray shielding rate of 40.86%, a thermal neutron shielding rate of 92.99%, and, after irradiation with a total gamma-ray dose of 10,000 Gy, a transmittance at 560 nm of 49.38% (a decrease of 21.84%).

### Comparative Example 6

The glass material of this comparative example consisted of, by mass percentage: 53.8% SiO₂, 24.2% PbO, 2.4% (Li-6) 20, 1.2% Na₂O, 14.6% K₂O, 1.8% CeO₂, and 2% B₂O₃. The glass material of this comparative example was prepared using quartz sand, red lead (Pb₃O₄), cerium oxide, sodium carbonate, potassium carbonate, boric acid, and lithium oxide as raw materials, according to the method of Example 1.

A 20 mm-thick sample of the glass material prepared by the method of this comparative example exhibited a ⁶⁰Co gamma-ray shielding rate of 23.26%, a thermal neutron shielding rate of 92.77%, and, after irradiation with a total gamma-ray dose of 10,000 Gy, a transmittance at 560 nm of 55.23% (a decrease of 11.12%).

The compositions and performances of the glass samples of Examples 1-7 and Comparative Examples 1-6 are shown in Tables 1 and 2, respectively. Table 1. Compositions of the glass samples in Examples 1-7 and Comparative Examples 1-6.

| Mass percent | Example | | | | | | | Comparative Example | | | | | |
|---|---|---|---|---|---|---|---|---|---|---|---|---|---|
| (wt %) | 1 | 2 | 3 | 4 | 5 | 6 | 7 | 1 | 2 | 3 | 4 | 5 | 6 |
| SiO₂ | 40.0 | 30.0 | 45.0 | 31.0 | 28.0 | 25.0 | 35.0 | 48.0 | 48.6 | 26.49 | 28.0 | 27.0 | 53.8 |
| PbO | 46.0 | 53.0 | 45.0 | 48.0 | 48.7 | 55.0 | 50.0 | 37.5 | 24.2 | 66.23 | 55.0 | 55.0 | 24.2 |
| Gd₂O₃ | 5.0 | 4.0 | 2.0 | 0.5 | 1.0 | 3.0 | 2.0 | 0.0 | 7.5 | 5.68 | 3.0 | 3.0 | 0.0 |
| CeO₂ | 0.5 | 0.6 | 0.5 | 1.5 | 1.0 | 1.2 | 1.5 | 1.5 | 1.4 | 0.0 | 1.2 | 1.2 | 1.8 |
| Al₂O₃ | 0.5 | 1.0 | 1.0 | 5.0 | 2.0 | 3.0 | 3.0 | 0.0 | 0.0 | 0.0 | 0.0 | 3.0 | 0.0 |
| Na₂O | 4.5 | 4.0 | 2.0 | 10.0 | 7.3 | 4.0 | 0.0 | 10.0 | 0.0 | 0.0 | 4.0 | 4.0 | 1.2 |
| K₂O | 2.0 | 6.9 | 2.5 | 3.9 | 10.0 | 6.8 | 6.0 | 3.0 | 18.1 | 1.60 | 6.8 | 6.8 | 14.6 |
| CaO | 1.0 | 0.5 | 1.0 | 0.0 | 1.5 | 2.0 | 2.0 | 0.0 | 0.0 | 0.0 | 2.0 | 0.0 | 0.0 |
| MgO | 0.5 | 0.0 | 1.0 | 0.1 | 0.5 | 0.0 | 0.5 | 0.0 | 0.0 | 0.0 | 0.0 | 0.0 | 0.0 |
| B₂O₃ | 0.0 | 0.0 | 0.0 | 0.0 | 0.0 | 0.0 | 0.0 | 0.0 | 0.0 | 0.0 | 0.0 | 0.0 | 2.0 |
| F | 0.0 | 0.0 | 0.0 | 0.0 | 0.0 | 0.0 | 0.0 | 0.0 | 0.2 | 0.0 | 0.0 | 0.0 | 0.0 |
| (Li-6)₂O | 0.0 | 0.0 | 0.0 | 0.0 | 0.0 | 0.0 | 0.0 | 0.0 | 0.0 | 0.0 | 0.0 | 0.0 | 2.4 |
| Total | 100 | 100 | 100 | 100 | 100 | 100 | 100 | 100 | 100 | 100 | 100 | 100 | 100 |

TABLE 2
Performance Test Results of Glass Samples from
Examples 1-7 and Comparative Examples 1-6

| | | | | Transmittance at 560 nm (%) | | | |
|---|---|---|---|---|---|---|---|
| | | ⁶⁰Co | Thermal | | After | | |
| Example/ | | gamma-ray | neutron | | gamma-ray | | |
| Comparative | | shielding | shielding | Before | irradiation | Difference | Thickness |
| Example | | rate (%) | rate (%) | irradiation | at 10,000 Gy | value | (mm) |
| Example | 1 | 40.78 | 96.00 | 90.01 | 83.55 | 6.46 | 20 |
| | 2 | 43.23 | 95.36 | 87.02 | 83.00 | 4.02 | 20 |
| | 3 | 40.47 | 93.65 | 89.62 | 82.95 | 6.67 | 20 |
| | 4 | 42.10 | 92.63 | 86.42 | 82.61 | 3.81 | 20 |
| | 5 | 42.49 | 93.13 | 88.68 | 84.26 | 4.42 | 20 |
| | 6 | 43.36 | 94.97 | 89.73 | 84.40 | 5.33 | 20 |
| | 7 | 43.08 | 93.97 | 87.11 | 82.89 | 4.22 | 20 |
| Comparative | 1 | 20.48 | 80.46 | 81.15 | 70.19 | 10.96 | 20 |
| Example | 2 | 19.02 | 96.26 | 65.11 | 58.35 | 6.76 | 20 |
| | 3 | 44.63 | 95.90 | 74.00 | 48.28 | 35.72 | 20 |
| | 4 | 39.99 | 92.42 | 69.21 | 52.61 | 16.60 | 20 |
| | 5 | 40.86 | 92.99 | 71.22 | 49.38 | 21.84 | 20 |
| | 6 | 23.26 | 92.77 | 66.35 | 55.23 | 11.12 | 20 |

As can be seen from Table 2, the radiation-resistant glass materials with gamma ray shielding and neutron protection functions in each example demonstrate that, in some embodiments of the present invention, the ⁶⁰Co gamma ray shielding rate of 20 mm thick samples is ≥40.47%; in some embodiments of the present invention, the thermal neutron shielding rate of 20 mm thick samples is ≥92.63%; in some embodiments of the present invention, the transmittance decrease (at 560 nm) of 20 mm thick samples after irradiation with a total dose of 10,000 Gy gamma rays is ≤6.67%.

The specific technical features described in the above embodiments of the present invention can be combined in any suitable manner without contradiction. To avoid unnecessary repetition, the present invention will not further describe various possible combinations.

The above descriptions are merely preferred embodiments of the present application and are not intended to limit the present application. Although the present application has been described in detail with reference to the foregoing embodiments, those skilled in the art can still modify the technical solutions described in the foregoing embodiments or make equivalent substitutions for some of the technical features therein. Any modifications, equivalent substitutions, improvements, etc. made within the spirit and principles of the present application shall be included within the scope of protection of the present application.

1. A glass material consisting of the following components in percent by mass: 25%-45% SiO₂, 48%-55% PbO, 0.5%-5% Gd₂O₃, 0.5%-1.5% CeO₂, 0.5%-5% Al₂O₃, 4%-10% Na₂O, 6.8%-10% K₂O, and 0-3% of an alkaline earth metal oxide selected from at least one of CaO and MgO, wherein CaO and MgO are not both 0% by mass.

2. The glass material according to claim 1, consisting of the following components in percent by mass: 25%-45% SiO₂, 48%-55% PbO, 0.5%-5% Gd₂O₃, 0.5%-1.5% CeO₂, 0.5%-5% Al₂O₃, 4%-10% Na₂O, 6.8%-10% K₂O, and 0.1%-3% of the alkaline earth metal oxide selected from at least one of the CaO and the MgO.

3. The glass material according to claim 1, wherein Gd₂O₃ is 1%-5% by mass.

4. The glass material according to claim 1, wherein CeO₂ is 0.5%-1.2% by mass.

5. The glass material according to claim 1, wherein Al₂O₃ is 0.5%-3% by mass.

6. The glass material according to claim 1, wherein Na₂O is 4%-7.3% by mass.

7. The glass material according to claim 1, wherein CaO is 0.5%-2% by mass.

8. The glass material according to claim 1, wherein MgO is 0-1% by mass.

9. The glass material according to claim 1, wherein a content of the alkaline earth metal oxide selected from at least one of the CaO and the MgO is 0.5%-2.5% by mass.

10. The glass material according to claim 1, consisting of the following components in percent by mass: 25%-45% SiO₂, 48%-55% PbO, 1%-5% Gd₂O₃, 0.5%-1.2% CeO₂, 0.5%-3% Al₂O₃, 4%-7.3% Na₂O, 6.8%-10% K₂O, and 0.1%-3% of the oxide selected from at least one of CaO and MgO.

11. The glass material according to claim 1, consisting of the following components in percent by mass: 25%-45% SiO₂, 48%-55% PbO, 1%-5% Gd₂O₃, 0.5%-1.2% CeO₂, 0.5%-3% Al₂O₃, 4%-7.3% Na₂O, 6.8%-10% K₂O, 0.5%-2% CaO, and 0-1% MgO.

12. The glass material according to claim 1, consisting of the following components in percent by mass: 25%-45% SiO₂, 48%-55% PbO, 1%-5% Gd₂O₃, 0.5%-1.2% CeO₂, 0.5%-3% Al₂O₃, 4%-7.3% Na₂O, 6.8%-10% K₂O, 1.5%-2% CaO, and 0-1% MgO.

13. The glass material according to claim 1, consisting of the following components in percent by mass: 25%-45% SiO₂, 48%-55% PbO, 1%-5% Gd₂O₃, 0.5%-1.2% CeO₂, 0.5%-3% Al₂O₃, 4%-7.3% Na₂O, 6.8%-10% K₂O, and 0.5%-2% CaO.

14. The glass material according to claim 1, wherein, at a thickness of 20 mm, the glass material has a ⁶⁰Co gamma-ray shielding rate ≥40.47%, a thermal neutron shielding rate ≥92.63%, a transmittance at 560 nm ≥86.42%, a transmittance at 560 nm after irradiation with gamma rays at a total dose of 10,000 Gy ≥82.61%, and a transmittance decrease at 560 nm after the irradiation ≤6.67%.

15. A method for preparing the glass material according to claim 1, comprising: mixing raw materials, high-temperature melting, auxiliary stirring and clarification, cooling and forming, and precision annealing, to obtain the glass material.

16. The method according to claim 15, wherein melting is conducted at 1,235-1,350 °C; forming is conducted at 1,108-1,222 °C; and annealing is conducted at 405-450 °C.

17. An article comprising the glass material of claim 1 for use in radiation shielding or optics.

18. The article according to claim 17, wherein the article is radiation shielding material or an optical element.

19. The article according to claim 17, wherein the optical element is an optical window element for shielding radiation.

20. A method of using the glass material of claim 1 in the field of radiation shielding or optics, the method comprising positioning, in a radiation path, a member selected from the group consisting of (i) the glass material and (ii) an article comprising the glass material, and, when the member is the article, the article being selected from the group consisting of a radiation shielding material and an optical element.
